(19) United States
(12) Patent Application Publication
(10) Pub. No.: US 2002/0054214 A1
(43) Pub. Date: May 9, 2002

(54) Signal prediction device and camera equipped with a signal prediction device

(75) Inventor: Toshikazu Yoshikawa, Tokyo (JP)

Correspondence Address: MORGAN LEWIS & BOCKIUS LLP, 1111 PENNSYLVANIA AVENUE NW, WASHINGTON, DC, 20004, US

(73) Assignee: NIKON CORPORATION

(21) Appl. No.: 09/957,610

(22) Filed: Sep. 21, 2001

(30) Foreign Application Priority Data
Sep. 22, 2000 (JP) 2000-289141

(51) Int. Cl. G03B 17/00; H04N 5/228

(52) U.S. Cl. 348/208; 396/54

(57) ABSTRACT

A signal prediction device and camera including a signal prediction device are provided in which the signal prediction device includes a signal detection part for detecting a signal series, a prediction coefficient calculation part for calculating prediction coefficients using the detected signal series, and a prediction calculation part for performing operations on the prediction coefficients and an updated signal series to predict future signals, wherein the updated signal series includes at least one future signal value for which a prediction operation has been previously performed from a signal series detected by the signal detection part and the prediction coefficients as the current signals.

### BACKGROUND OF THE INVENTION

1. Field of the Invention

The present invention relates to a signal prediction device, and more particularly, to a signal prediction device that predicts movement signals in order to prevent deterioration of a photographic image from vibration, and further relates to a camera equipped with a signal prediction device and a compensation device for compensating movement based on the prediction results.

2. Description of the Related Art

There are a variety of proposed techniques or devices to prevent deterioration of an image caused by movement of a photographic device, such as movement caused by hand movement. Among these proposed techniques are methods of predicting hand movement, as disclosed in Japanese Patent Application Nos. H5-204012, H5-204013, and H5-204014. In these methods, a system including detecting equipment, such as angular velocity sensors and CCDs, periodically samples the hand movement of the photographer as time series waveform data. Hand movement is compensated based on prediction data generated from the time series waveform. By predicting near future values of the sampled waveform data, these systems may compensate for movement by either deciding whether to prohibit or permit exposure at a near future instant of time or correcting an optical system of a photographic device using an actuator.

In the related art techniques, data used as the prediction values of the waveform data are obtained by selecting multiple pieces of data from past hand movement sampling data (which includes the point in time at which the prediction is made) for a set interval of time and adding the results of various data that have been multiplied by a coefficient called the “prediction coefficient.” The prediction coefficient is calculated by applying a model equation for prediction to a sufficiently large sampling data series using the least squares method.

The methods of the above-described related art systems have several drawbacks. First, the amount of hand movement can only be predicted for a single point in time. Second, since a time interval ending with the predicted single point of time is determined at a stage when the least squares method is applied to calculate the prediction coefficient, the time interval is fixed upon entering the stage when the waveform is predicted, resulting in less freedom to change the time interval. In order to change the time interval, it is necessary to recalculate the prediction coefficient by reapplying the least squares method to new past data.

Consequently, in order to perform predictions for points in time corresponding to two or more different time intervals (e.g., a long time interval and short time interval), it is necessary to perform least squares method calculations equal in number to the number of time points to be a predicted in order to calculate sets of prediction coefficients. It is also necessary to store sets of prediction coefficients equal in number to the number of time points to be predicted. This requires a heavy burden of calculation and long calculation times, making it difficult to perform prediction operations at high speed and requires a large amount of memory to store the plurality of prediction coefficients.

Another drawback associated with the methods of the related art is that sufficient prediction precision may not be obtained because calculation of the prediction coefficients is performed by least squares multiple regression techniques, which may cause the precision to vary depending on the vibration waveform of the hand movement amount that is to be predicted and the time interval to be predicted in the future.

Moreover, the prediction degree in the related art method is determined by first statistically surveying vibration waveforms for the amount of hand movement from a plurality of samples in advance, and then setting the degree. Consequently, the degree is fixed, which makes it impossible to perform an optimal prediction responsive to changes, such as when a different photographer uses the device or when the trend in the vibration waveforms (e.g., the amount of hand movement) changes greatly with different photographic situations.

### SUMMARY OF THE INVENTION

Accordingly, the present invention is directed to a signal prediction device and a camera equipped with a signal prediction device that substantially obviates one or more of the problems due to limitations and disadvantages of the related art.

Given the above-mentioned problems, one object of the present invention is to provide a vibration amount prediction device which enables prediction of the amount of vibration of future movement at any time interval once the prediction coefficient sets are calculated without requiring recalculation thereof, to a photographic device equipped with this vibration amount prediction device. The present invention allows for high-speed prediction of a plurality of vibration amounts for future movement amounts, such as hand movements and the like, of a plurality of time intervals from a single prediction coefficient set, increased prediction precision, and setting a prediction degree that is optimal for photography.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the signal prediction device and camera equipped with a signal prediction device includes a signal detection part that detects signal series, a prediction coefficient calculation part that calculates prediction coefficients using the detected signal series, and a prediction calculation part that performs operations to predict future signals using the calculated prediction coefficients and a signal series updated by treating future signals for which a prediction operation has been previously performed from signal series detected by the above-mentioned signal detection part and the above-mentioned prediction coefficients as current signals.

With the present invention, once a future signal has been predicted from a detected signal series and a prediction coefficient, this predicted signal is incorporated as a current signal. Thus, the next future signals are predicted one after the other.

In another aspect of the present invention, a signal prediction device and camera equipped with a signal prediction device includes a signal prediction device characterized by being equipped with a signal detection part that detects signal series, a prediction coefficient calculation part that calculates prediction coefficients using the above-mentioned detected signal series, and a prediction calculation part that performs operations to predict future signals from the linear weighted sum of the above-mentioned prediction coefficients and a signal series updated by treating future signals for which a prediction operation has been previously performed from the linear weighted sum of signal series detected by the above-mentioned signal detection part and the above-mentioned prediction coefficients as the current signals.

In a further aspect of the present invention, a camera includes a photographic lens, an image detection part, a signal prediction device, and a hand movement compensation part that compensates to minimize hand movement based on the hand movement signal predicted by the signal prediction device. The signal prediction device of the camera includes a signal detection part for detecting a camera hand movement signal series, a prediction coefficient calculation part for calculating prediction coefficients using the detected signal series, a prediction calculation part for performing operations on the prediction coefficients and an updated signal series to predict future signals. The updated signal series includes at least one future signal value for which a prediction operation has been previously performed from a signal series detected by the signal detection part and the prediction coefficients as a current signal.

In another aspect of the present invention, a camera includes a photographic lens, an image detection part, a signal prediction device, and a hand movement compensation part that compensates to minimize hand movement based on the hand movement signal predicted by the signal prediction device. The signal prediction device of the camera includes a signal detection part for detecting a camera hand movement signal series, a prediction coefficient calculation part for calculating prediction coefficients using the detected signal series, a prediction calculation part for performing operations on a linear weighted sum of the prediction coefficients and an updated signal series to predict future signals. The updated signal series includes at least one future signal value for which a prediction operation has been previously performed from the linear weighted sum of the signal series detected by the signal detection part and the prediction coefficient as a current signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic diagram of an exemplary signal prediction device in accordance with the present invention.

FIG. 2 is a schematic diagram of an exemplary prediction coefficient calculation part in accordance with the present invention.

FIG. 3 is a diagram illustrative of predicting one sampling into the future using the past samples in accordance with the present invention.

FIG. 4 is a diagram that illustrative of predicting two samplings into the future using three past samples in accordance with the present invention.

FIG. 5 is a diagram that shows an example of forward prediction error.

FIG. 6 is a diagram that shows an example of backward prediction error.

FIG. 7 shows an exemplary hand movement compensation camera with a built-in hand movement signal prediction device in accordance with the present invention.

FIG. 8 is a diagram illustrative of an exemplary embodiment that predicts a plurality of futures.

### DESCRIPTION OF THE PREFERRED EMBODIMENTS

Reference will now be made in detail to the preferred embodiments of the present invention, examples of which are illustrated in the accompanying drawings. In order to facilitate understanding of the present invention, it will first be described from the standpoint of its operating principles.

An AR filter (Auto Regressive filter) is one type of digital filter that is widely used. An AR filter is a linear filter that has a function that can be expressed by Equation 1:

$$x ( n ) + {\sum }_{k = 1}^{m} {a}_{k} x ( n - k ) = e ( n ) .$$

Here, x(n) is the signal input to the filter at time n (where n is an integer), e(n) is the signal output from the filter at time n, and aₖ is the weighting coefficient of past input signal x(n−k), wherein k is a positive integer of 1 or more and m (where m is a positive integer) or less. In other words, the AR filter is a filter that outputs the signal e(n) of the sum of the current signal and the linear weighted sum of the past input m signal series x(n−m), x(n−m+1), x(n−m+2), . . . , x(n−2), x(n−1) when the current (time (n)) signal x(n) is input. Here, the weighting coefficients a₁ to aₘ of the AR filter are determined appropriately, and it is assumed that 0 is always output when a given signal series is input to this filter. This is expressed by Equation 2:

$$x ( n ) + {\sum }_{k = 1}^{m} {a}_{k} x ( n - k ) = 0 ; \\ - {\sum }_{k = 1}^{m} {a}_{k} x ( n - k ) = x ( n ) .$$

Then, it can be said that Equation 2 expresses a filter function that outputs the current signal prediction value x(n) from a series of m signals input in the past as the linear weighted sum of that series of m signals. When time is advanced one unit, this changes as shown in Equation 3:

$$- {\sum }_{k = 1}^{m} {a}_{k} x ( n - k + 1 ) = x ( n + 1 ) .$$

It can be said that Equation 3 expresses a filter function that outputs the prediction value x(n+1) of a signal one time unit in the future from the current signal and m signals input in the past. In other words, it is able to predict the signal one time unit into the future from the current value and m signals input in the past.

This is a type of linear prediction method, where m is the degree of prediction, and coefficient aₖ is the prediction coefficient.

Here, if input signal series x(n) is the waveform data of the vibration amount output from the detector, the amount of vibration can be predicted by performing the operation of Equation 3.

To predict future signals using Equation 3, it is necessary to find the set of coefficients aₖ that always output 0 when a given signal series is input in Equation 2, i.e., the prediction coefficients. With the present invention, the approach of the Burg method (the Burg method or the maximum entropy method) may be applied to the initial N signals that are to be predicted, although it is extremely rare that there is a coefficient set aₖ that satisfies the filter expressed by Equation 2 completely in actual signals. In other words, the right side of Equation 1 (i.e., e(n)) is expressed in the form of a prediction error that has a finite size. With regard to the handling of this error in the Burg method, the error is divided into two errors (i.e., the forward prediction error and backward prediction error, described below), and the prediction coefficient is determined based on a standard of minimizing the sum of the respective squares. The forward prediction error fe^{(m)}(n) and backward prediction error be^{(m)}(n) referred to here are expressed respectively by Equation 4 and Equation 5 for m degrees. Here, the kth prediction coefficient at the mth prediction degree is expressed as aₖ^{(m)}.

Equation 4:

$$f {e}^{( m )} ( n ) = x ( n ) + {\sum }_{k = 1}^{m} {a}_{k}^{( m )} x ( n - k ) .$$

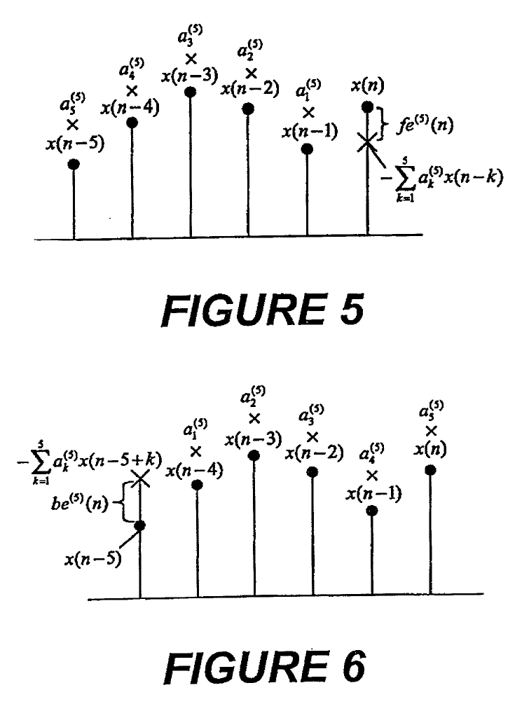

Equation 5:

$$b {e}^{( m )} ( n ) = x ( n - m ) + {\sum }_{k = 1}^{m} {a}_{k}^{( m )} x ( n - m + k ) ,$$

where n=m, m+1, . . . , N−1. An example when the degree is 5 is shown in FIGS. 5 and 6.

Here, if Equation 4 and Equation 5 are modified using a reflection coefficient cₘ defined by Equation 6, the forward prediction error and backward prediction error are expressed as Equation 7 and Equation 8, respectively.

Equation 6:

cₘ=aₘ^{(m)};

aₖ^{(m)}=aₖ^{(m-1)}+cₘaₘ₋ₖ^{(m-1)};

where k=1,2, . . . ,m−1.

Equation 7:

fe^{(m)}(n)=fe^{(m-1)}(n)+cₘbe^{(m-1)}(n−1).

Equation 8:

be^{(m)}(n)=be^{(m-1)}(n−1)+cₘfe^{(m-1)}(n).

In both Equation 7 and Equation 8, n=m, m+l, . . . , N−1.

The reflection coefficient cm may be determined by a standard of minimizing the sum of the respective squares of the forward and backward prediction errors. The value of cₘ that makes Equation 9 its minimum is given by Equation 10.

Equation 9:

$${\sum }_{n = m}^{N - 1} [ {\{ f {e}^{( m )} ( n ) \}}^{2} + {\{ b {e}^{( m )} ( n ) \}}^{2} ] .$$

Equation 10:

$${c}_{m} = - \frac{2 {\sum }_{n = m}^{N - 1} f {e}^{( m - 1 )} ( n ) \cdot b {e}^{( m - 1 )} ( n - 1 )}{{\sum }_{n = m}^{N - 1} [ {\{ f {e}^{( m - 1 )} ( n ) \}}^{2} + {\{ b {e}^{( m - 1 )} ( n - 1 ) \}}^{2} ]} .$$

The prediction coefficient aₖ^{(m)} can be found from cₘ using a recurrence formula. By substituting the prediction coefficient aₖ^{(m)} thus calculated and the measured values of the signal series (x(n−m+1), x(n−m+2), . . . , x(n−1), x(n)) into Equation 3, the future signal can be predicted as x(n+1).

The prediction calculation described above can be performed in multiple instances at any time. In other words, once the prediction coefficient set has been calculated, it is possible to predict signals one sampling time interval into the future (i.e., one unit of time ahead), one after the other, any number of times and at any time, by sequentially substituting the m past signals including the current signal into Equation 3.

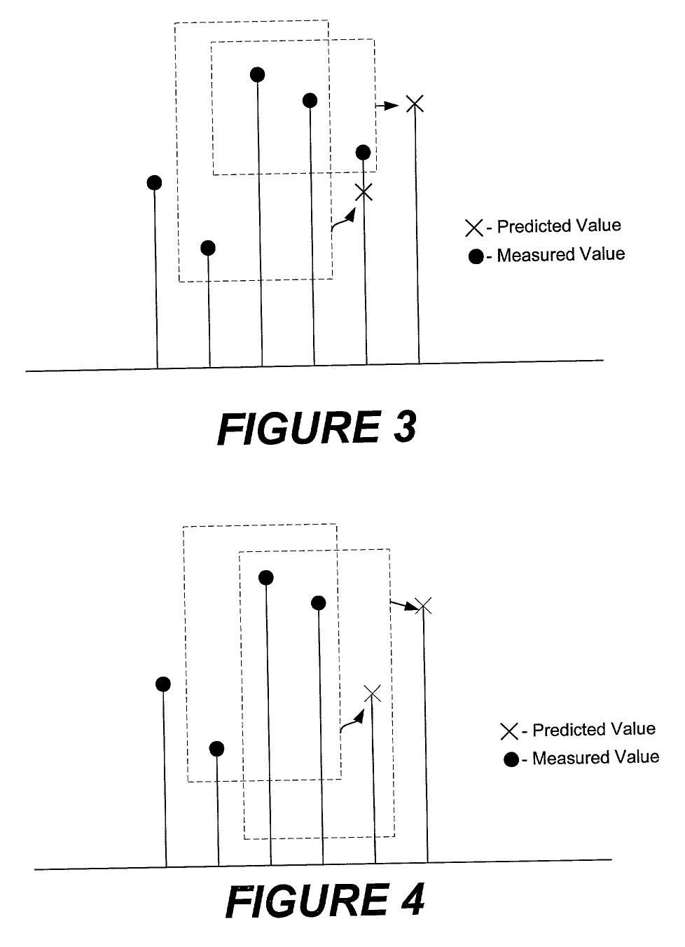

FIG. 3 shows the manner of prediction as described above. In this figure, prediction is performed twice, as illustrated by the two boxes, each outlining three sample points. The second prediction is performed one sampling after the initial prediction, but it is to be understood that this may be done any number of samplings later.

The inventor of the present invention has determined that a prediction could be made for the next future signal, i.e., the signal two samplings ahead, by reusing Equation 3 if the calculated prediction value x(n+1) is considered to be the current signal. For that reason, the oldest signal x(n−m+1) is discarded in Equation 3 and n−1 is used as n (i.e., replace n with n−1). This replacement operation corresponds to carrying over the time by one unit only. The predicted value x(n+1) is used in place of the current value x(n) in Equation 3 and x(n+1) is calculated as the next future predicted value. The above prediction calculation can be repeated any number of times, and repeating it n times gives the signal n samplings into the future. In other words, once the prediction coefficient set is calculated, signals can be repeatedly predicted one sampling time into the future (one time interval forward), one after the other, by successively substituting the past m signal amounts including the current one into Equation 3. If this prediction calculation is repeated m+1 times or more, we can eventually predict future signals m+1 samplings or more into the future using only the prediction calculated signal series. This allows the prediction of any number of future signals with any type of timing, at timing precision determined by the sampling time interval set in advance, even using a plurality of time intervals. FIG. 4 shows examples of prediction one sampling ahead and two samplings ahead with the above-mentioned prediction degree at 3 (i.e., m=3).

As described above, once a prediction coefficient has been calculated, the present invention enables prediction of a future random time interval ahead without recalculating the prediction coefficients and also enables prediction of signals a plurality of sampling time intervals ahead.

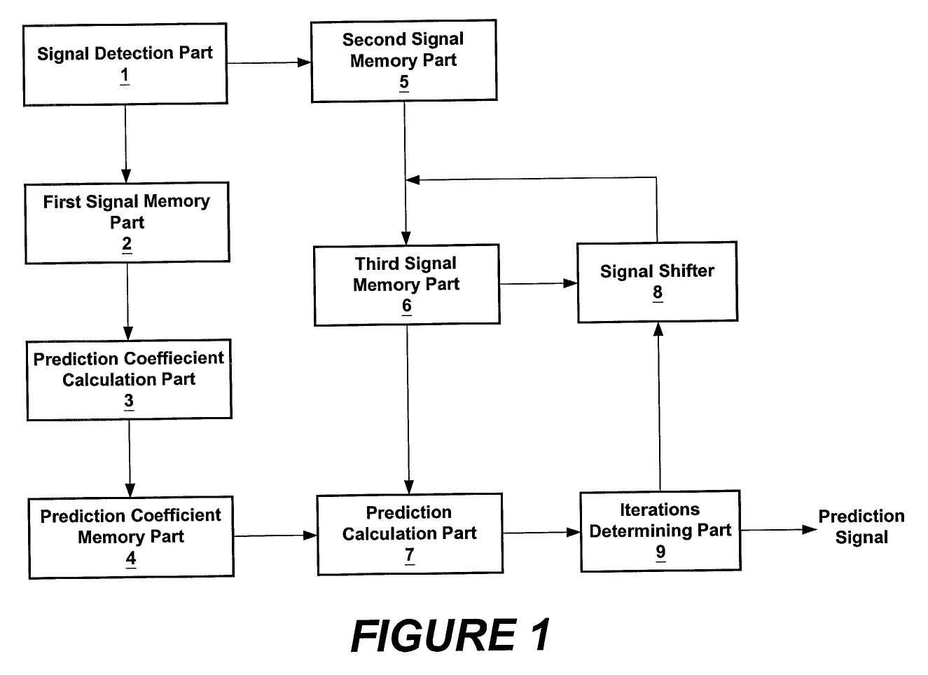

FIG. 1 is a schematic diagram of an exemplary signal prediction device in accordance with the present invention that predicts signals two or more samplings ahead. As shown in FIG. 1, the exemplary signal prediction device includes a signal detection part 1, a first signal memory part 2, a prediction coefficient calculation part 3, a prediction coefficient memory part 4, a second signal memory part 5, a third signal memory part 6, a prediction calculation part 7, a signal shifter 8, and an iterations determining part 9.

The signal detection part I detects signals, and the first signal memory part 2 and the second signal memory part 5 store the respective signal data. A prediction coefficient calculation part 3 calculates a prediction coefficient for predicting signals from signal data output from the first signal memory part 2. The prediction coefficient memory part 4 stores prediction coefficients output from the prediction coefficient calculation part 3. The third signal memory part 6 stores signal data output from the second signal memory part 5. The prediction calculation part 7 multiplies and adds prediction coefficients output from the prediction coefficient memory part 4 with signal data output from the third signal memory part 6, and calculates the prediction signal. An iterations determining part 9 determines whether the number of iterations of the operation performed in the prediction calculation part 7 has reached the specified number by comparing it to the specified number of iterations determined in advance, based on the desired time interval until the future that is to be predicted and stored. If the number of iterations is determined to have reached the specified number of operations, the operation result is output as the prediction signal. If the number of iterations is determined to not have reached the specified number of operations, a hand movement signal shifter 8 shifts up the signal data stored in the third signal memory part 6 by one unit only in the direction of the past, considers the prediction signal calculated by the prediction calculation part 7 to be the current signal data, updates the signal data by discarding the oldest signal, and stores the updated signal data in the third signal memory part 6. Next, the prediction calculation part 7 performs multiplication and addition with the updated signal data output from the third signal memory part 6 and the prediction coefficient output from the prediction coefficient memory part 4, and calculates the prediction signal. These processes are repeated, the signal data stored in the third signal memory part 6 is updated, and prediction signals are output that correspond to values farther and farther into the future.

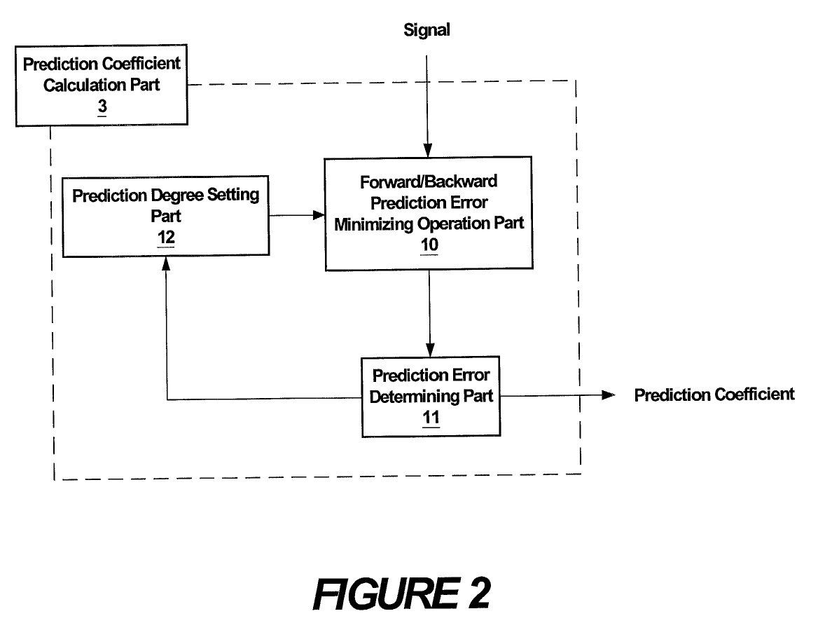

While there are no particular restrictions on the constitution of the prediction coefficient calculation part 3 described above, a preferable example of the constitution is shown in FIG. 2. As shown in FIG. 2, the prediction coefficient calculation part 3 may include a forward/backward prediction error minimizing operation part 10, a prediction error determining part 11, and a prediction degree setting part 12. The forward/backward prediction error minimizing operation part 10 calculates the prediction coefficient set that minimizes forward prediction error and backward prediction error based on the signal output from the first signal memory part 2 (see FIG. 1) as well as the prediction error for that prediction coefficient set, and then outputs them. A prediction error determining part 11 determines whether the prediction error output from the forward/backward prediction error minimizing operation part 10 is within permissible values, and outputs the prediction coefficient when the prediction error is within the permissible values. When the prediction error determining part 11 determines that the prediction error exceeds the permissible value, the prediction degree setting part 12 calculates a resetting signal for the prediction degree to increase the prediction degree and outputs the resetting signal to the forward/backward prediction error minimizing operation part 10. Thus, a prediction coefficient with the appropriate degree for the specified precision can be calculated, which makes it possible to solve the problem of increased operation time from unnecessary operations caused when a degree is raised excessively high for the required precision, as well as the problem of prediction precision not satisfying specifications when the degree is conversely too low for the required precision. For Example, when the signal in question is a camera hand movement signal, an appropriate prediction degree can be set according to the photographer and the photographic circumstances.

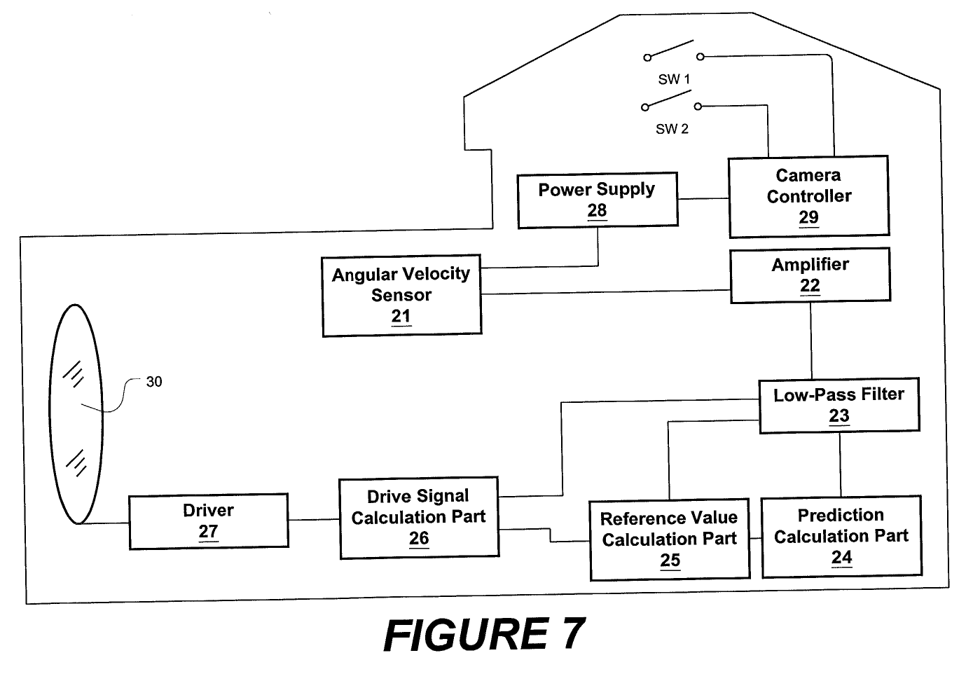

An exemplary configuration in the case of application of the signal prediction device of the present invention to a camera will be described below with reference to FIG. 7, where the signal is a hand movement signal. However, it is to be understood that the present invention may be used in other applications and include different configurations.

FIG. 7 is a block diagram that shows an exemplary configuration of a hand movement compensation camera incorporating a hand movement amount prediction device in accordance with the present invention. The hand movement amount prediction device includes an angular velocity sensor 21 for detecting vibration, an amplifier 22, a low-pass filter 23, a prediction calculation part 24, a reference value calculation part 25, a driver 27, a power supply 28, a camera controller 29, and a hand movement compensation lens 30, which together constitute part or all of a photographic lens. Furthermore, SW1 is a half-press switch, and SW2 is a full-press switch.

The angular velocity sensor 21 functions to detect angular velocity acting on the camera. For example, the angular velocity sensor 21 may detect a Coriolis force from the vibration acting on the sensor itself and outputs a voltage value proportional to the force. Typically, a total of two sensors are installed, one corresponding to each axis so that angular velocity along two axes may be detected. An amplifier 22 amplifies the output voltage value of the angular velocity sensor 21 and sends the amplified signal to a low-pass filter 23. The low-pass filter 23 cuts high frequency components, such as noise from the signal output from the amplifier 22. This may be done utilizing analog or digital signal processing (DSP) techniques, such as performing operations digitally on the signal from the amplifier using a CPU or by using an analog filter that utilizes electric circuits, for example. From numerous measurements, it has been found that most human angular velocity vibrations contain vibration components up to about 20 Hz on the high frequency end, so it is preferable that the cut-off frequency of the low-pass filter be made larger than the high-end frequency. However, if the cut-off frequency is set too high, it becomes difficult to effectively drop out noise components of high frequency. Conversely, if the cut-off frequency is set too low, there is a danger of partially cutting off high frequency components of the signal. Both cases lead to a decrease in the signal to noise ratio (S/N) of the signal, which is undesirable because it may lower prediction precision. Thus, it is desirable to appropriately determine the cut-off frequency.

The output of the low-pass filter 23 is sent to the reference value calculation part 25, the prediction calculation part 24, and the drive signal calculation part 26. The prediction calculation part 24 may be constituted as shown in FIG. 1. The prediction calculation part 24 uses the angular velocity signal from the low-pass filter 23 to perform an operation to predict the size of the angular velocity. The angular velocity prediction signal resulting from this operation is output to the reference value calculation part 25. The reference value calculation part 25 calculates the reference value from the angular velocity prediction signal and the angular velocity signal from the low-pass filter 23, and then outputs the reference value to the drive signal calculation part 26. This reference value is a value that should be indicative of the reference value for the past, current, and future angular velocities. For example, the time-averaged value of the angular velocity signal from the low-pass filter 23 and the prediction signal of the angular velocity may be used.

The drive signal calculation part 26 subtracts the calculated reference value from the angular velocity signal input from the low-pass filter 23. This subtracted value is an amount corresponding to the amount of change in the future angular velocity signal. Afterward, an integration operation is performed on this subtracted value over a specified time. By performing this integration, the amount corresponding to the change of the future angular velocity signal may be converted into an angular displacement signal. Furthermore, an operation to convert the angular displacement signal to a drive signal for the hand movement compensation lens drive signal may be performed, and the drive signal may then be sent to the driver 27.

The driver 27 may be equipped with a servo circuit (not shown) for control and an actuator for driving a hand movement compensation lens 30 or other corrective optics. For example, a servo circuit for control may engage an actuator that moves the hand movement compensation lens while also controlling the amount of movement of the hand movement compensation lens 30. The hand movement compensation lens 30 may be built into the photographic optical system of the photographic device and constitute at least one part of this photographic optical system, and an actuator in the driver 27 drive the hand movement compensation lens 30. The direction in which the actuator is driven is in a direction that cancels out the displacement of the image from the predicted angular displacement, and which also is the direction perpendicular to the optical axis of the photographic optical system. Furthermore, the amount an actuator is driven may be adjusted so that it becomes an amount necessary to sufficiently cancel out the amount of displacement of the image from the predicted angular displacement. Driving of the hand movement compensation lens 30 also may be synchronized to the angular displacement prediction signal. Thus, the optical axis of the photographic optical system of a camera is decentered by providing an angular displacement, and image blur is corrected by canceling out the image displacement from hand movement. The present invention can thus substantially decrease or eliminate deterioration in image quality, such as from image blur in the camera photographic image. A photographic lens equipped with a hand movement compensation lens of the present invention may be of an exchangeable type, such as in a single lens reflex or of a non-exchangeable type as in a compact camera, for example.

The half-press switch SW1 is a switch that turns on in correspondence with a half-press action of a release button (i.e., shutter button, not shown). The full-press switch SW2 is a switch that turns on in correspondence with a fall-press action of the release button. The camera controller 29 may be equipped with a controller for controlling the operation of the entire camera, and a half-press timer (not shown) may be provided in the controller. The half-press timer and the half-press switch SW1 of the camera turn on simultaneously. While the half-press switch SW1 is depressed, it stays on, and stays on for a set period of time even after the half-press switch SW1 goes off.

A power supply 28 continues to supply power to the angular velocity sensor 21 while the camera controller 29 is on. When the camera controller 29 is off, supply of power to the angular velocity sensor 21 stops. Consequently, the camera can detect hand movement signals using the angular velocity sensor 21 only while the camera controller 29 is on.

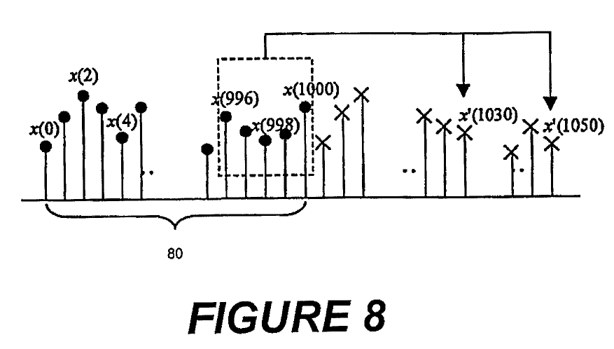

Next, a case in which hand movement signals are constantly predicted 30 msec and 50 msec in the future will be explained with reference to FIGS. 1, 2, 7, and 8, as an exemplary embodiment of the use of a hand movement signal prediction device in a camera. FIG. 8 shows a hand movement signal output from an angular velocity sensor mounted on a photographic device as an example of the hand movement that is to be predicted. Generally, hand movement occurs in the three directions: pitch, yaw, and roll. To facilitate understanding of the invention, the exemplary embodiment deals with prediction and compensation of signals in only one direction; however, it is to be understood that the same principles may be applied in other directions.

In FIG. 8, each hand movement signal is sampled for a one msec interval. During photography, a signal output from the angular velocity sensor for one second is held in a first signal memory part 2 in FIG. 1 at the point when the switch for driving the hand movement compensation mechanism turns on. When N=1001 (x(0) to x(1000) in the figure) pieces of hand movement signal data are stored in the first signal memory part 1, this hand movement signal data is sent to a prediction coefficient calculation part 3 of FIG. 1. A forward/backward prediction error minimizing operation part 10 of the prediction coefficient calculation part 3 in FIG. 2 performs an operation to minimize the forward prediction error and backward prediction error using the above-mentioned maximum entropy method. For example, it finds a third-degree prediction coefficient and the dispersion of prediction error at that time. When it finds the dispersion of prediction error, that dispersion value is assessed to see if it falls within the permissible error range by a prediction error determining part 11. If the dispersion value does not fall within the permissible error range, the prediction degree is increased by one in the prediction degree setting part 12, and the forward/backward prediction error minimizing operation part 10 then again finds a fourth-degree prediction coefficient and the dispersion of prediction error at that time. The operation is repeated, increasing the prediction degree until it is determined that the value falls within the permissible error range in the prediction error determining part 11.

An example will now be explained in which the prediction error dispersion is determined to fall within the permissible error range by the prediction error determining part 11 when the degree of prediction is five. In FIG. 1, when the prediction coefficient calculation part 3 finds five prediction coefficients a₁ to a₅, its output is stored in the prediction coefficient memory part 4. When the prediction degree is determined, five pieces of hand movement signal data, for example, x(996) through x(1000) output from the angular velocity sensor 21 are stored in the second signal memory part 5 as data to be used for prediction. Furthermore, the same data as that stored in the second signal memory part 5 are temporarily stored in the third signal memory part 6. An operation is performed by a prediction calculation part 7 to predict a hand movement signal x′(1001) using Equation 3 from the five pieces of data held in the third signal memory part 6 and the five prediction coefficients stored in the prediction coefficient memory part 4. This prediction operation result is the hand movement signal one msec in the future.

Next, the iterations determining part 9 determines the number of iterations that the operation is repeated. The iterations determining part 9 stores 30 and 50 operation iterations corresponding to the futures to be predicted 30 and 50 msec in the future. The iterations determining part 9 therefore determines that the number of the iterations of the operation has not reached the specified number, and sends predicted data x′(1001) to a signal shifter 8. The signal shifter 8 treats this predicted data as the current data, and resets the data that was stored in the third signal memory part 6 to a total of five pieces of data consisting of x(997) through x(1000) and the predicted data x′(1001). The prediction calculation part 7 then predicts data x′(1002) using these new five pieces of data and the prediction coefficients stored in the prediction coefficient memory part 4.

Next, iterations determining part 9 again checks the number of iterations of the operation. At this stage, the number of operation iterations is two. This procedure is repeated, substituting in the newly calculated prediction data as current data successively, until the number of operation iterations reaches 30. The result is the prediction of a hand movement signal x′(1030) 30 msec in the future. By again repeating the operation similarly another 20 times, the hand movement signal x′(1050) 50 msec in the future is also predicted. In other words, in this embodiment, hand movement signals x′(1030) and x′(1050) are predicted from hand movement signal data x(996) through x(1000). When the actually measured signal x(1001) is output from the angular velocity sensor 21 in FIG. 7, the second signal memory part 5 discards data x(996) and stores data x(997) through x(1001). It can then predict future hand movement signals for two time intervals x′(1031) and x′(1051) from data x(997) through x(1001) and prediction coefficients using the same procedure as described above.

The present invention allows for preparations to drive an actuator based on prediction signals in the distant future, the actuator to be driven with high precision from prediction values in the near future, and compensation to be performed, for example, for cases in which there are problems from time lags between reception of the signal and actual operation of the actuator by predicting future hand movement signals for these two time intervals.

In the example described above, two futures were predicted; however, it is to be understood that in the present invention more or less than two futures can be predicted.

While the present invention is described above in the exemplary configurations and the exemplary embodiment as relating prediction of camera hand movement signals, it is to be understood that the present invention also may be used for other movement prediction, such as ordinary vibration prediction and prediction of other physical quantities, for example.

The present invention allows the effects described below to be obtained.

The present invention performs prediction operations for a next future signal using a predicted future signal as the current signal, and thus allows prediction of the next future signal.

The invention may perform prediction operations using a linear weighted sum of a signal series and prediction coefficient set. Thus, the invention enables the prediction operation to be performed at high speed and with sufficient prediction precision.

The present invention may be equipped with first, second, and third signal memory parts and an iterations determining part for operations, so together with the above-described effects of the invention, the present invention can count the number of iterations of this operation by changing the specified iterations for the operation, thereby enabling multiple future signal prediction for any time, whether in the near or distant future.

The present invention may calculate prediction coefficients that minimize forward prediction error and backward prediction error, as well as the prediction error for these prediction coefficients, using a prediction coefficient calculation part. The invention further increases the degree of the prediction and resets when a prediction error does not satisfy the specified precision. Therefore, the most suitable degree of prediction may be determined for the specified precision together with the foregoing described effects of the invention. Consequently, prediction precision of the signal is neither too great nor too low.

The signal prediction device of the present invention may be used on camera hand movement signals, so the camera hand movement signal can be favorably predicted.

The present invention may include a camera with the hand movement signal prediction device described as well as with a hand movement compensation part that minimizes hand movement based on the prediction signals predicted by this hand movement signal prediction device. Therefore, the camera of the present invention has extremely little image deterioration caused by image blur.

It will be apparent to those skilled in the art that various modifications and variations can be made in the signal prediction device and camera equipped with a signal prediction device of the present invention without departing from the spirit or scope of the invention. Thus, it is intended that the present invention cover the modifications and variations of this invention provided they come within the scope of the appended claims and their equivalents.

That which is claimed is:

1. A signal prediction device, comprising:
a signal detection part for detecting a signal series;
a prediction coefficient calculation part for calculating prediction coefficients using the detected signal series; and
a prediction calculation part for performing operations on the prediction coefficients and an updated signal series to predict future signals, wherein the updated signal series includes at least one future signal value for which a prediction operation has been previously performed from a signal series detected by the signal detection part and the prediction coefficients as a current signal.

2. The signal prediction device according to claim 1, further comprising:
an iterations determining part for determining whether the number of iterations of the prediction operation has reached a specified number determined by the desired time interval until the future that is to be predicted;
a first signal memory part for storing signal series composed of a plurality of past detected signals;
a second signal memory part for storing signal series composed of the latest of a plurality of detected signals; and
a third signal memory part that stores signal series output from the second signal memory part in the initial stages, but discards the oldest signal in said signal series every time it determines that the specified number is not reached while also adding a future signal resulting from a prediction operation as a current signal, thereby performing the updating, wherein the prediction coefficient calculation part calculates the prediction coefficients using the signal series stored in the above-mentioned first signal memory part, and the prediction calculation part performs an operation to predict future signals using the prediction coefficients and the signal series stored in the third signal memory part.

3. The signal prediction device according to claim 2, wherein the prediction coefficient calculation part comprises:
a forward/backward prediction error minimizing operation part for calculating the prediction coefficients minimizing forward prediction error and backward prediction error as well as prediction error for the prediction coefficients;
a prediction error determining part that determines whether the prediction error for the prediction coefficient satisfies a specified precision; and
a prediction degree setting part that raises the prediction degree and resets when the prediction error is determined to not satisfy the specified precision by the prediction error determining part.

4. The signal prediction device according to claim 3, wherein the signal includes a camera hand movement signal.

5. The signal prediction device according to claim 2, wherein the signal includes a camera hand movement signal.

6. The signal prediction device according to claim 1, wherein the prediction coefficient calculation part comprises:
a forward/backward prediction error minimizing operation part for calculating the prediction coefficients based on minimizing a forward prediction error, a backward prediction error and a prediction error for the prediction coefficients;
a prediction error determining part that determines whether the forward/backward prediction error satisfies a specified precision; and
a prediction degree setting part that raises the prediction degree and resets when the prediction error is determined to not satisfy the specified precision by the prediction error determining part.

7. The signal prediction device according to claim 6, wherein the signal includes a camera hand movement signal.

8. A signal prediction device, comprising:
a signal detection part for detecting a signal series;
a prediction coefficient calculation part for calculating prediction coefficients using the detected signal series; and
a prediction calculation part for performing operations on a linear weighted sum of the prediction coefficients and an updated signal series to predict future signals, wherein the updated signal series includes at least one future signal value for which a prediction operation has been previously performed from the linear weighted sum of the signal series detected by the signal detection part and the prediction coefficient as a current signal.

9. The signal prediction device according to claim 8, further comprising:
an iterations determining part for determining whether the number of iterations of the prediction operation has reached a specified number determined by the desired time interval until the future that is to be predicted;
a first signal memory part for storing signal series composed of a plurality of past detected signals;
a second signal memory part for storing signal series composed of the latest of a plurality of detected signals; and
a third signal memory part that stores signal series output from the second signal memory part in the initial stages, but discards the oldest signal in said signal series every time it determines that the specified number is not reached while also adding a future signal resulting from a prediction operation as a current signal, thereby performing the updating, wherein the prediction coefficient calculation part calculates the prediction coefficients using the signal series stored in the above-mentioned first signal memory part, and the prediction calculation part performs an operation to predict future signals using the prediction coefficients and the signal series stored in the third signal memory part.

10. The signal prediction device according to claim 9, wherein the prediction coefficient calculation part comprises:
a forward/backward prediction error minimizing operation part for calculating the prediction coefficients minimizing forward prediction error and backward prediction error as well as prediction error for the prediction coefficients;
a prediction error determining part that determines whether the prediction error for the prediction coefficient satisfies a specified precision; and
a prediction degree setting part that raises the prediction degree and resets when the prediction error is determined to not satisfy the specified precision by the prediction error determining part.

11. The signal prediction device according to claim 10, wherein the signal includes a camera hand movement signal.

12. The signal prediction device according to claim 9, wherein the signal includes a camera hand movement signal.

13. The signal prediction device according to claim 8, wherein the prediction coefficient calculation part comprises:
a forward/backward prediction error minimizing operation part for calculating the prediction coefficients based on minimizing a forward prediction error, a backward prediction error and a prediction error for the prediction coefficients;
a prediction error determining part that determines whether the forward/backward prediction error satisfies a specified precision; and
a prediction degree setting part that raises the prediction degree and resets when the prediction error is determined to not satisfy the specified precision by the prediction error determining part.

14. The signal prediction device according to claim 13, wherein the signal includes a camera hand movement signal.

15. A camera, comprising:
a photographic lens;
an image detection part,
a signal prediction device; and
a hand movement compensation part that compensates to minimize hand movement based on a hand movement signal predicted by the signal prediction device, wherein the signal prediction device comprises:
a signal detection part for detecting a camera hand movement signal series;
a prediction coefficient calculation part for calculating prediction coefficients using the detected signal series;
a prediction calculation part for performing operations on the prediction coefficients and an updated signal series to predict future signals, wherein the updated signal series includes at least one future signal value for which a prediction operation has been previously performed from a signal series detected by the signal detection part and the prediction coefficients as a current signal.

16. The camera according to claim 15, wherein the signal prediction device further comprises:
an iterations determining part for determining whether the number of iterations of the prediction operation has reached a specified number determined by the desired time interval until the future that is to be predicted;
a first signal memory part for storing signal series composed of a plurality of past detected signals;
a second signal memory part for storing signal series composed of the latest of a plurality of detected signals; and
a third signal memory part that stores signal series output from the second signal memory part in the initial stages, but discards the oldest signal in said signal series every time it determines that the specified number is not reached while also adding a future signal resulting from a prediction operation as a current signal, thereby performing the updating, wherein the prediction coefficient calculation part calculates the prediction coefficients using the signal series stored in the above-mentioned first signal memory part, and the prediction calculation part performs an operation to predict future signals using the prediction coefficients and the signal series stored in the third signal memory part.

17. The camera according to claim 16, wherein the prediction coefficient calculation part comprises:
a forward/backward prediction error minimizing operation part for calculating the prediction coefficients minimizing forward prediction error and backward prediction error as well as prediction error for the prediction coefficients;
a prediction error determining part that determines whether the prediction error for the prediction coefficient satisfies a specified precision; and
a prediction degree setting part that raises the prediction degree and resets when the prediction error is determined to not satisfy the specified precision by the prediction error determining part.

18. The camera according to claim 15, wherein the prediction coefficient calculation part comprises:
a forward/backward prediction error minimizing operation part for calculating the prediction coefficients based on minimizing a forward prediction error, a backward prediction error and a prediction error for the prediction coefficients;
a prediction error determining part that determines whether the forward/backward prediction error satisfies a specified precision; and
a prediction degree setting part that raises the prediction degree and resets when the prediction error is determined to not satisfy the specified precision by the prediction error determining part.

19. A camera, comprising:
a photographic lens;
an image detection part;
a signal prediction device; and
a hand movement compensation part that compensates to minimize hand movement based on a hand movement signal predicted by the signal prediction device, wherein the signal prediction device comprises:
a signal detection part for detecting a camera hand movement signal series;
a prediction coefficient calculation part for calculating prediction coefficients using the detected signal series; and
a prediction calculation part for performing operations on a linear weighted sum of the prediction coefficients and an updated signal series to predict future signals, wherein the updated signal series includes at least one future signal value for which a prediction operation has been previously performed from the linear weighted sum of the signal series detected by the signal detection part and the prediction coefficient as a current signal.

20. The camera according to claim 19, wherein the signal prediction device further comprises:
an iterations determining part for determining whether the number of iterations of the prediction operation has reached a specified number determined by the desired time interval until the future that is to be predicted;
a first signal memory part for storing signal series composed of a plurality of past detected signals;
a second signal memory part for storing signal series composed of the latest of a plurality of detected signals; and
a third signal memory part that stores signal series output from the second signal memory part in the initial stages, but discards the oldest signal in said signal series every time it determines that the specified number is not reached while also adding a future signal resulting from a prediction operation as a current signal, thereby performing the updating, wherein the prediction coefficient calculation part calculates the prediction coefficients using the signal series stored in the above-mentioned first signal memory part, and the prediction calculation part performs an operation to predict future signals using the prediction coefficients and the signal series stored in the third signal memory part.

21. The camera according to claim 20, wherein the prediction coefficient calculation part comprises:
a forward/backward prediction error minimizing operation part for calculating the prediction coefficients minimizing forward prediction error and backward prediction error as well as prediction error for the prediction coefficients;
a prediction error determining part that determines whether the prediction error for the prediction coefficient satisfies a specified precision; and
a prediction degree setting part that raises the prediction degree and resets when the prediction error is determined to not satisfy the specified precision by the prediction error determining part.

22. The camera according to claim 19, wherein the prediction coefficient calculation part comprises:
a forward/backward prediction error minimizing operation part for calculating the prediction coefficients based on minimizing a forward prediction error, a backward prediction error and a prediction error for the prediction coefficients;
a prediction error determining part that determines whether the forward/backward prediction error satisfies a specified precision; and
a prediction degree setting part that raises the prediction degree and resets when the prediction error is determined to not satisfy the specified precision by the prediction error determining part.
